(19) United States
(12) Patent Application Publication
(10) Pub. No.: US 2014/0190834 A1
(43) Pub. Date: Jul. 10, 2014

(54) PLATING PROCESS

(71) Applicant: GENERAL ELECTRIC COMPANY, Schenectady, NY (US)

(72) Inventors: Eklavya CALLA, Bangalore (IN); Krishnamurthy ANAND, Bangalore (IN); Chakrakody SHASTRY, Bangalore (IN)

(73) Assignee: GENERAL ELECTRIC COMPANY, Schenectady, NY (US)

(21) Appl. No.: 13/735,293

(22) Filed: Jan. 7, 2013

(51) Int. Cl. B05D 7/24; C25D 3/02

(52) U.S. Cl. CPC B05D 7/24; C25D 3/02
USPC 205/115; 205/118; 427/430.1; 427/597; 427/421.1; 427/404; 427/595; 427/299; 427/290

(57) ABSTRACT

A plated component and a plating process are disclosed. The plating process includes applying a material to a region of a component, the material being selected from the group consisting of nickel, cobalt, chromium, iron, aluminum, or a combination thereof. The region includes a single crystal microstructure, includes a directionally solidified microstructure, is substantially devoid of equiaxed microstructure, or a combination thereof. The applying includes electroplating, electroless plating, or the electroplating and the electroless plating. The plated component includes an electroplated region, an intermediate layer on the electroplated region, and an overlay coating on the intermediate layer.

### FIELD OF THE INVENTION

The present invention is directed to processes of treating manufactured components. More particularly, the present invention relates to processes of plating components.

### BACKGROUND OF THE INVENTION

Many systems, such as those in gas turbines, are subjected to thermally, mechanically and chemically hostile environments. For example, in the compressor portion of a gas turbine, atmospheric air is compressed to 10-25 times atmospheric pressure, and adiabatically heated to about 800° F. to about 1250° F. in the process. This heated and compressed air is directed into a combustor, where it is mixed with fuel. The fuel is ignited, and the combustion process heats the gases to very high temperatures, in excess of about 3000° F. These hot gases pass through the turbine, where airfoils fixed to rotating turbine disks extract energy to drive the fan and compressor of the turbine, and the exhaust system, where the gases provide sufficient energy to rotate a generator rotor to produce electricity.

To improve the efficiency of operation of turbines, combustion temperatures have been raised and are continuing to be raised. To withstand these increased temperatures, components can include single crystal or directionally solidified alloys. These components can be formed with the single crystal or directionally solidified microstructures through controlled casting processes.

In components having superalloys with equiaxed microstructures, repair processes include cleaning cracked or damaged surfaces, then weld repairing the surfaces, then machining/grinding the component to a final shape/dimensions, and, optionally, coating the surfaces, for example, with a thermal barrier coating. Such repair processes are not suitable for single crystal or directionally solidified microstructures because, for example, the repair process can introduce strain energy to components having single crystal or directionally solidified microstructures, thereby resulting in undesirable recrystallization under high temperatures.

A process capable of plating and/or repairing components having single crystal or directionally solidified microstructures and a plated that do not suffer from one or more of the above drawbacks would be desirable in the art.

### BRIEF DESCRIPTION OF THE INVENTION

In an exemplary embodiment, a plating process includes applying a material to a region of a component, the material being selected from the group consisting of nickel, cobalt, chromium, iron, aluminum, or a combination thereof. The region includes a single crystal microstructure, includes a directionally solidified microstructure, is substantially devoid of equiaxed microstructure, or a combination thereof. The applying includes at least one of electroplating and electroless plating.

In another exemplary embodiment, a plating process includes removing an existing material from a region of a component, applying a material to the region by electroplating, applying a build material to the region by a build-up technique, and applying an overlay coating to the build material.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic view of an exemplary process of electroplating a component according to the disclosure.

FIG. 2 is a schematic view of an exemplary process of electroplating a component according to the disclosure.

FIG. 3 is relative plot of stress-strain properties for a plated component according to the disclosure.

Wherever possible, the same reference numbers will be used throughout the drawings to represent the same parts.

### DETAILED DESCRIPTION OF THE INVENTION

Provided is an exemplary process of plating a component. Embodiments of the present disclosure permit repair of components having single crystal or directionally solidified microstructures, permit broader use of components having a single crystal or directionally solidified microstructure, permit use of components at higher temperatures, extend the operational life of components, permit increased efficiency for gas turbines, or combinations thereof.

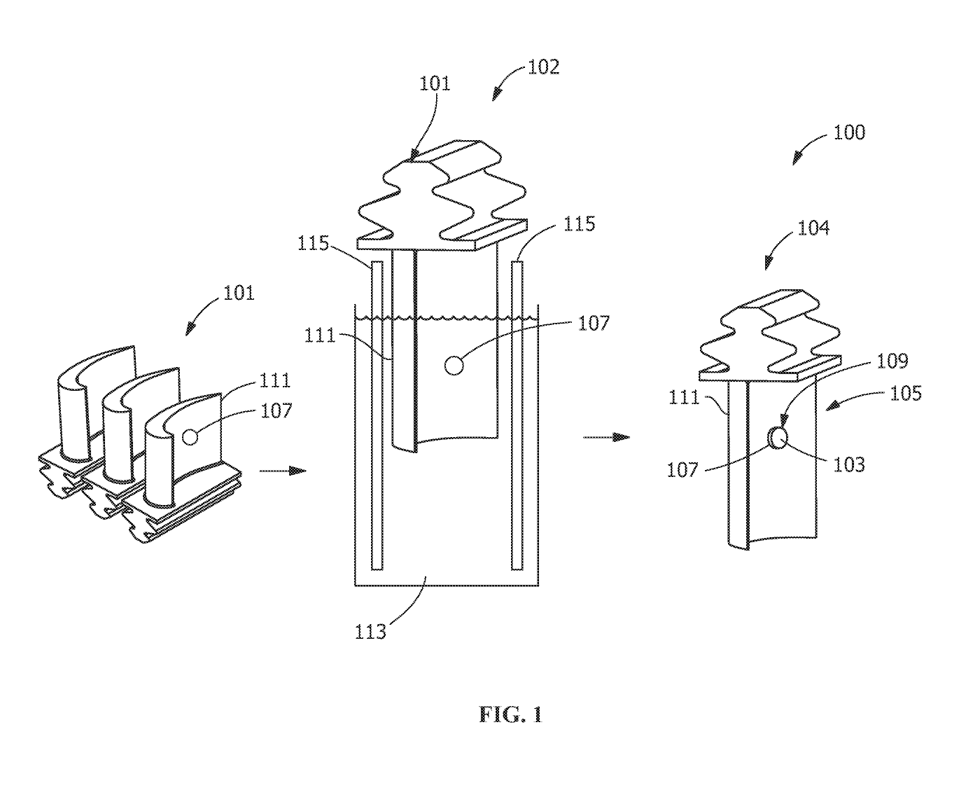

FIG. 1 schematically shows a process 100 with exaggerated layers for illustration purposes. In one embodiment, the process 100 includes an electroplating process and/or an electroless plating process, includes applying a material 103 to a region 107 of a component 101 (step 102) to form a plated component 105 (step 104). The material 103 is nickel, cobalt, chromium, iron, aluminum, or a combination thereof. The component 101 is any suitable component. Suitable components include, but are not limited to, turbine components, such as, hot gas path components, blades/buckets, dovetails, rotors, seals, industrial components, automobile parts, electronic parts, other suitable manufactured goods, or a combination thereof.

The material 103 is applied (step 102) by electroplating and/or electroless plating in a region 107 of the component 101, for example, with one or more electrodes 115. In one embodiment, the applying (step 102) includes techniques for directing and controlling the amount and/or location of the material 103, for example, masking In one embodiment, plating is done by a brush-plating process. In another embodiment, a non-plating process is employed, such as, a any process capable of depositing the material 103, for example, diffusion coating, sputter coating, or other similar application techniques. In one embodiment, electroplating is used and includes supplying electrons to form a non-ionic coating in the region 107, for example, with a solution 113, such as a chemical solution. In one embodiment, electroless plating is used and includes simultaneous reactions in the solution 113, such as an aqueous solution, by using a reducing agent to release hydrogen from the aqueous solution, thereby producing a negative charge in the region 107. In one embodiment, the electroless plating is a UV-assisted electroless technique. In one embodiment, the material 103 is applied (step 102) by electroplating and electroless plating to form a plated layer 109.

The region 107 of the component 101 has a single crystal microstructure, a directionally solidified microstructure, the single crystal microstructure and the directionally solidified microstructure, is substantially devoid of equiaxed microstructure, or a combination thereof. In one embodiment, the region 107 includes an equiaxed microstructure that is susceptible to damage during a repair process, for example, when an interlayer is welded or spray coated. The region 107 is positioned on any suitable portion of the component 101. In one embodiment, the region 107 is a substrate 111 of the component 101 or is on the substrate 111.

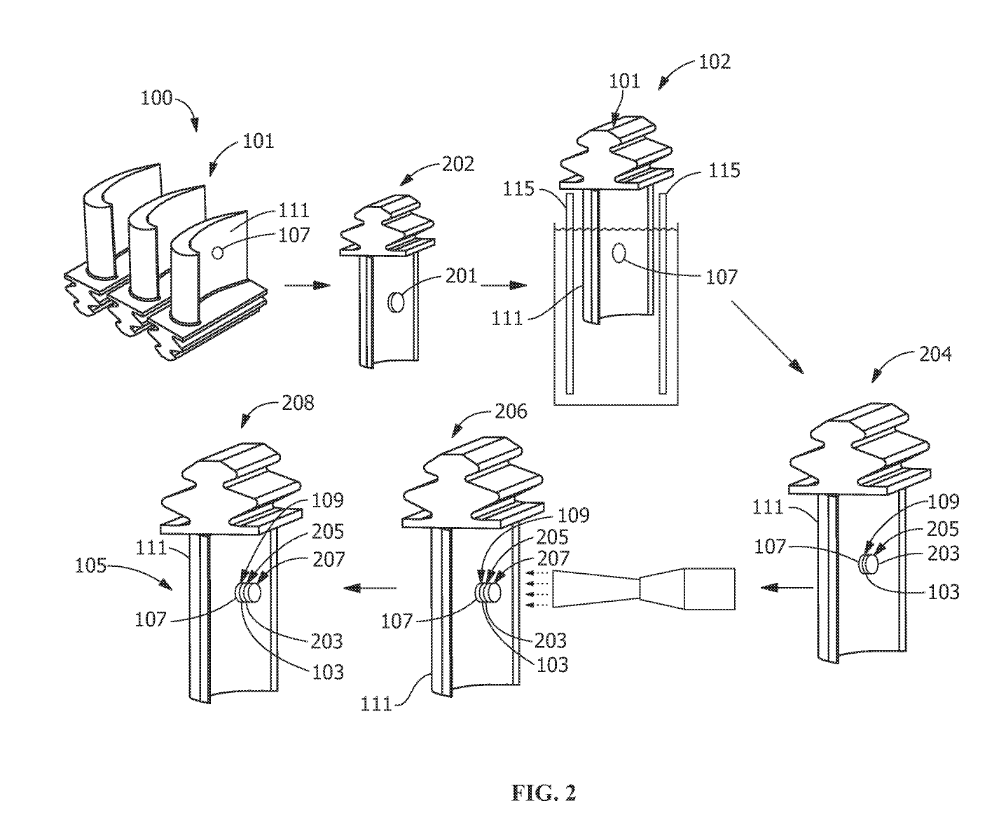

FIG. 2 schematically shows an embodiment of the process 100 with exaggerated layers for illustration purposes. In one embodiment, the process 100 includes one or more additional steps before or after the material 103 is applied (step 102). For example, in one embodiment, the substrate 111 is prepared (step 202) prior to the material 103 being applied (step 102). The preparing (step 202) includes any suitable methods. Suitable methods include, but are not limited to, removing selected material 201 in the region 107, machining the selected material 201 in the region 107, grinding the selected material 201 in the region 107, or a combination thereof.

In one embodiment, the process 100 includes build material 203 that is applied (step 204) to the material 103 by another suitable method after the applying (step 102) by electroplating and electroless plating to form the plated layer 109. The build material 203 has the same microstructure and/or composition as the material 103 or a different microstructure and/or composition as the material 103 from the material 103. Suitable methods for applying (step 204) the build material 203 include, but are not limited to, welding, spraying, laser deposition, electron beam deposition, or a combination thereof. In a further embodiment, the build material 203 that is applied (step 204) forms an intermediate layer 205 positioned on or proximal to the plated layer 109.

In one embodiment, the process 100 includes applying an overlay coating 207 (step 206) to the region 107. In one embodiment, the overlay coating 207 is applied (step 206) by a spray technique, such as, a thermal spray process or a cold spray process. In one embodiment, the overlay coating 207 is a thermal barrier coating, a rub-resistant coating, a thermally grown oxide, or a combination thereof.

In one embodiment, the process 100 includes applying heat (step 208) to the region 107, thereby diffusing the material 103 of the plated layer 109 into the substrate 111. The diffusion improves the bond between the substrate and the plated layer 109. Additionally or alternatively, heat is applied by operation of the component in a hot gas path.

In one embodiment, the amount of the material 103 applied (step 102) and/or the amount of the build material 203 applied (step 204) corresponds to the composition and properties of the material 103 and/or the build material 203, the composition and properties of the substrate 111, and additional steps performed as part of the process 100. For example, in one embodiment, the thickness of the material 103 and/or the build material 203 is sufficient to absorb impact of sprayed particles (not shown) applied in subsequent steps. In this embodiment, the region 107 of the component 101 is not strained due to the impact of the sprayed particles. In one embodiment, the process 100 does not impart notable stress or strain into the region 107. In one embodiment, the process 100 does impart strain into the overlay coating 207. In one embodiment, the process 100 is performed without using shot peening.

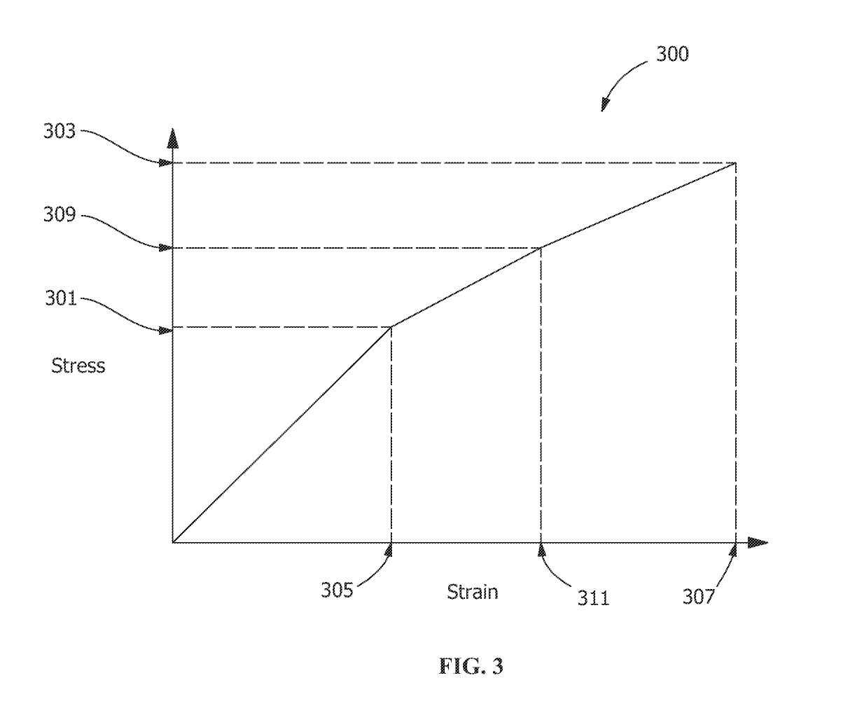

In one embodiment, the region 107 of the component 101 includes a nickel-based alloy having a single crystal microstructure and a composition of, by weight, about 10% chromium, up to about 8% cobalt, about 4% aluminum, about 3.5% titanium, about 2% molybdenum, about 6% tungsten, up to about 5% tantalum, about 0.5% niobium/columbium, incidental impurities, and a balance of nickel. FIG. 3 shows a plot of stress-strain properties 300 of the plated component 105 corresponding to this embodiment. Specifically, FIG. 3 shows the stress-strain properties 300 with the mathematic assumptions that entire kinetic energy of impinging particles go into the plated component 105 and dissipative losses, such as heat and/or vibration, are not present. In this embodiment, the plated component 105 is a portion of a turbine bucket/blade with sprayed particles applied at a velocity between about 500 meters per second and about 2,000 meters per second.

For the nickel-based alloy described above, the plated layer 109 and/or the intermediate layer 205 has a range of thickness for the material 103 capable of being calculated based upon the properties shown in FIG. 3. For example, FIG. 3 shows yield strength 301 of this embodiment of the plated component 105, ultimate yield strength 303 of this embodiment of the plated component 105, a first strain value 305 corresponding to the yield strength 301 and a second strain value 307 corresponding to the ultimate yield strength 303.

Utilizing Equation 1, kinetic energy density (KED) can be correlated in view of the particle velocity range (ν) and density (ρ) of the material 103. For example, the kinetic energy density is represented by the following:

KED=½ρν² (Equation 1)

By utilizing Equations 2 and 3, identifying an intermediate stress value 309 (δ), and identifying a corresponding intermediate strain value 311, the range of the thickness for the material 103 is capable of being calculated. For example, the intermediate stress value 309 (δ) is represented by the following relationship with the intermediate strain value 311 (e), the first strain 305 (e_{YS}), the second strain 307 (e_{UTS}), the yield strength 301 (YS), and the ultimate yield strength 303 (UYS):

δ=(e(UYS−YS)+(e_{UTS})YS−(e_{YS})UYS)/(e_{UTS}−e_{YS}) (Equation 2)

The energy per unit volume (EPUV) corresponding to the deformation shown in FIG. 3 is represented by incorporating the above representation of the intermediate stress value 309 as follows:

EPUV=½(YS)(e_{YS})+((YS+δ)/2)(e−e_{YS}) (Equation 3)

Substituting Equation 2 into Equation 3 permits calculation of a thickness for the material 103 and/or the build material 203. In one embodiment, the thickness is between about 15 microns and about 70 microns. Similarly, in other embodiments, the thickness of the material 103 corresponds to calculations based upon the materials and process parameters used.

In one embodiment, for about 20 micron cubic particles of a nickel-based alloy (for example, a nickel-based alloy having a composition, by weight, of about 9.75% chromium, about 7.5% cobalt, about 4.2% aluminum, about 3.5% titanium, about 1.5% molybdenum, about 6.0% tungsten, about 4.8% tantalum, about 0.5% niobium, about 0.15% hafnium, about 0.05% carbon, about 0.004% boron, and a balance of nickel) at about 800° F. impinging at velocities distributed between about 500 m/s and about 2000 m/s, the thickness ranges from about 15 microns to about 70 microns.

In one embodiment, for about 20 micron cubic particles of a titanium-based alloy (for example, a titanium-based alloy having a composition, by weight, of about 6% aluminum, about 2% tin, about 2% zirconium, about 2% molybdenum, about 2% chromium, about 0.25% silicon, and a balance of titanium) at about 600° F. impinging at velocities distributed between about 500 m/s and about 2000 m/s, the thickness ranges from about 9 microns to about 43 microns.

In one embodiment, for about 20 micron cubic particles of an iron-based alloy (for example, an iron-based alloy having a composition, by weight, of about 0.08% carbon, between about 8% and about 10.5% nickel, between about 18% and about 20% chromium, about 2% manganese, about 0.045% phosphorous, about 0.03% sulfur, about 1% silicon, and a balance of iron) at about 600° F. impinging at velocities distributed between about 500 m/s and about 2000 m/s, the thickness ranges from about 27 microns to about 112 microns.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A process of plating, the process comprising:
applying a material to a region of a component, the material being selected from the group consisting of nickel, cobalt, chromium, iron, aluminum, or a combination thereof;
wherein the region includes a single crystal microstructure, includes a directionally solidified microstructure, is substantially devoid of equiaxed microstructure, or a combination thereof;
wherein the applying includes at least one of electroplating and electroless plating.

2. The process of claim 1, further comprising applying a build material to the material by a technique selected from the group consisting of welding, spraying, laser deposition, electron beam deposition, or a combination thereof.

3. The process of claim 1, further comprising applying an overlay coating.

4. The process of claim 3, wherein the applying of the overlay coating is by a spray technique.

5. The process of claim 3, wherein the overlay coating is selected from the group consisting of a thermal barrier coating, a rub-resistant coating, a thermally grown oxide, or a combination thereof.

6. The process of claim 3, wherein the process imparts strain into overlay coating.

7. The process of claim 1, wherein the electroplating is a UV-assisted electroless technique.

8. The process of claim 1, further comprising removing selected material in the region prior to the applying of the material to the region.

9. The process of claim 8, wherein the removing is by a repair technique selected from the group consisting of cleaning, machining, grinding, and combinations thereof.

10. The process of claim 1, wherein the process does not impart strain into the region.

11. The process of claim 1, further comprising applying heat to diffuse at least a portion of the material applied by the electroplating into a substrate in the region.

12. The process of claim 1, wherein the turbine component is selected from the group consisting of a nozzle blade, bucket, a dovetail, a rotor, a seal, or a combination thereof.

13. The process of claim 1, further comprising determining a thickness for the material through calculations based upon a stress-strain plot.

14. A process of plating, the process comprising:
removing an existing material from a region of a component;
applying a material to the region by electroplating;
applying a build material to the region by a build-up technique; and
applying an overlay coating to the build material.

15. The process of claim 14, wherein the material applied is selected from the group consisting of nickel, cobalt, chromium, iron, aluminum, or a combination thereof

16. The process of claim 14, further comprising applying the build material applied in the region by a technique selected from the group consisting of welding, spraying, laser deposition, electron beam deposition, or a combination thereof.

17. The process of claim 14, wherein the overlay coating is a thermal barrier coating, a rub-resistant coating, a thermally grown oxide, or a combination thereof.

18. The process of claim 14, wherein the process does not impart strain to the region.

19. The process of claim 14, wherein the process imparts strain into the overlay coating.
